(19) United States
(12) Patent Application Publication
(10) Pub. No.: US 2004/0166471 A1
(43) Pub. Date: Aug. 26, 2004

(54) Method and device for optical measurement of a cast model of a tooth in restorative dentistry

(75) Inventors: Matthias Schussler, Karlsbad (DE); Paul Weigl, Bad Homburg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Polytec GmbH, Waldbronn (DE)

(21) Appl. No.: 10/783,568

(22) Filed: Feb. 20, 2004

(30) Foreign Application Priority Data
Feb. 20, 2003 (DE) 103 07 436.8

(51) Int. Cl. A61C 9/00; A61C 1/00

(52) U.S. Cl. 433/72; 433/29

(57) ABSTRACT

For non-contact and non-destructive measurement of surfaces of cast models of a tooth in restorative dentistry, a coherent-radar device, whose measurement direction is brought generally into alignment with the insertion or placement direction for the dental restoration is used, with the help of a real-time video image, which is recorded either in the insertion or placement direction. The sample holder is a commercially available magnetic tilting table. A light source can be used, which has a narrow bandwidth of about 3-40 nanometers.

### BACKGROUND

The invention relates to a method and a device for optical measurement of a cast model of a tooth in restorative dentistry.

More specifically, for the production of tooth crowns and bridges for restoring teeth, attempts have been made, not in the least for cost reasons, to automate the conventionally handmade production of tooth replacements. For the mechanized or even completely automated production of such tooth replacements, however, a data set on the exact dimensions of the crown or bridge to be produced must be provided. One region which has especially strict requirements on dimensional tolerances is the contact surface between the tooth stump ground by the dentist and the tooth replacement, which is to be set on the tooth stump and which has to be produced. Therefore, a very precise measurement of the ground tooth stump is imperative. In addition, it is also important to measure the adjacent teeth and their distance to the ground tooth stump.

Typically, it is not the tooth stump itself, but instead a cast model of this tooth stump that is measured. Conventionally, this is performed either by contact, that is, by means of mechanical scanning, or by means of an optical, three-dimensional measurement of the tooth by stripe projection, that is, a triangulation method.

Triangulation is very well suited for the measurement of diffuse reflective surfaces. However, problems with this method include measurement uncertainty, which increases with increasing work distance; the fact that the tooth to be measured is illuminated with a stripe pattern, while a camera records the picture from a different direction, so that shadows are generated by the adjacent teeth; and also the requirement to measure the tooth from all possible spatial directions, which generates large amounts of data through a high number of individual measurements, whose integration for three-dimensional representation of the tooth is very complicated. These attendant circumstances, which are typical for a stripe-projection measurement, also require that the tooth stump to be measured in the cast model is isolated from the adjacent teeth and must be fixed rigidly to a sample holder, typically by means of pouring plaster around the tooth model in the sample holder. Furthermore, combining the measurement data generates errors, which occasionally exceed the allowed tolerances.

### SUMMARY

The present invention is based on the object of creating a method and a device for optical measurement of a cast model of a tooth in restorative dentistry, with which the measurement, particularly of a tooth prepared by a dentist, that is, not only a tooth stump, but also, e.g., a tooth prepared for receiving an implant, can be performed more simply and more quickly than before, but nevertheless with the required accuracy.

This object is achieved by a method as well as with a device in accordance with the invention. The invention is distinguished mainly in that the cast model is measured with a coherent-radar device. Beforehand, the cast model and the coherent-radar device are aligned relative to each other such that the direction of the measurement beam of the coherent-radar device (that is, its Z-direction) essentially coincides with the insertion or placement direction of the dental restoration. This is based on the knowledge that a tooth, which has been ground for tooth replacement, has no undercuts when viewed in the direction, in which the tooth replacement is inserted or set. Therefore, if the prepared tooth is measured from this direction, absolutely no undercuts have to be taken into account, so that one measurement is sufficient to represent the tooth surface of interest. Further measurement data from other spatial directions can largely be eliminated. In this way, the amount of data generated during the measurement becomes smaller, and various pictures from different spatial directions also do not have to be assembled to obtain a three-dimensional picture of the sample. The teaching according to the invention thus enables considerable data reduction and much simpler evaluation of the data obtained during the measurement.

The alignment of the coherent-radar device and the cast model of the tooth to be restored with dental restoration is performed according to the invention with the help of a real-time video image, which shows at least the tooth to be restored from the Z-direction of the coherent-radar device. In particular, through corresponding alignment of the sample holder, which can be monitored and controlled in real time on the video monitor, the dental technician can produce the alignment according to the invention quickly and simply, preferably by hand. Because the illumination direction in the coherent-radar device corresponds to the Z-direction, the dental technician can recognize on the video image that the monitoring direction, that is, the Z-direction, essentially coincides with the insertion or placement direction of the dental restoration.

Coherent-radar devices are known. One such device is described, e.g., in a publication from VDI-Technologiezentrum Physikalische Technologien “Info-Börse-Laser,” Edition No. 36/April 1999. This publication provides a device, which allows the principle of interferometry for shape recognition to be used also for optically rough surfaces. Both smooth and also rough surfaces can be measured precisely down to a micrometer in the Z-direction. In this way, the measurement uncertainty is independent of distance.

The sample holder for the cast model of the tooth to be measured is preferably a commercially available magnetic tilting table that is present in any dental laboratory. This enables very simple holding for the cast model and a similarly simple alignment according to the method of the invention with the help of the real-time video image.

In an especially preferred embodiment, the coherent-radar device used in accordance with the invention is modified such that white light is no longer used for the measurement. Instead, a light source with a narrow bandwidth, typically between 3-40 nanometers, is used. By reducing the bandwidth, the measurement accuracy does decrease in the Z-direction; but it still lies in the range around 10 micrometers, which is tolerable for this application. In contrast, by reducing the bandwidth of the measurement light, the measurement rate and the number of valid measurement points are increased.

Known coherent-radar devices have a defined measurement field with a defined number of measurement points. Especially for the production of bridges, however, the extent of this measurement field is often insufficient to be able to represent all of the associated teeth in one picture. For this purpose, it is proposed that to enlarge the measurement field, two partially overlapping measurements are performed. These two measurements can be combined either by shifting the cast model in a defined way relative to the coherent-radar device and orthogonal to the Z-direction, i.e., the adjustment of the sample holder is always constant and is included in the calculation of the representation of the measurement results, which enables the construction of an “overlapping” image. Alternatively or in combination with this measure, the shift between the two measurements, however, can also be determined by a computer from the overlapping area of the measurement data with reference to a comparison of the associated measurement data.

However, to enlarge the measurement field, an exchangeable camera objective can also be provided. This can enlarge the measurement field, wherein, however, it must be taken into account that the lateral resolution is reduced. However, normally the lateral resolution still corresponds to requirements when a camera objective is used, which enlarges the measurement field.

### BRIEF DESCRIPTION OF THE DRAWINGS

A preferred embodiment of the invention is described and explained in more detail in the following with reference to the attached drawings. Shown are:

FIG. 1 is a diagrammatic view showing a device according to the invention with an object table that can move horizontally;

FIG. 2 is a diagrammatic view, similar to FIG. 1, but with an exchangeable objective for the camera.

### DETAILED DESCRIPTION OF THE PREFERRED EMBODIMENTS

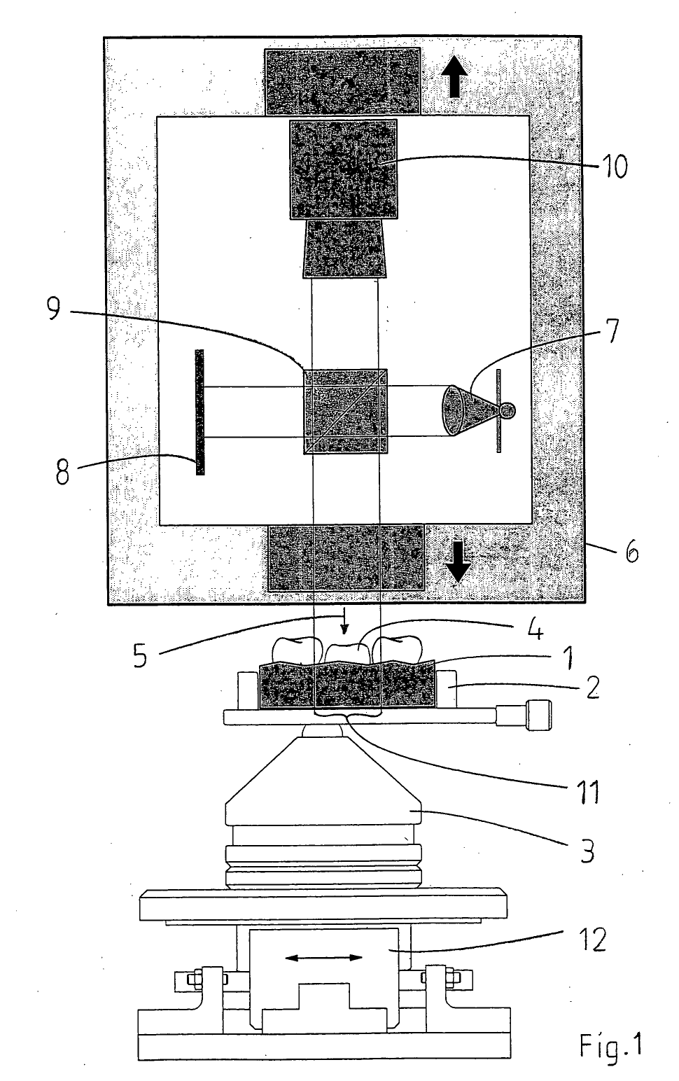

In FIG. 1, the principle construction of a device according to the invention is shown. A cast model 1 is held in a sample holder 2 of a magnetic tilting table 3. The tooth 4 to be restored with dental restoration (not shown, because it is still to be produced) is ground and aligned for placement of a crown, such that it exhibits no resistance against the placement of the crown in the placement direction 5 (Z-direction) and in particular, features no undercuts. According to the invention, the Z-direction of a coherent-radar device 6, which essentially comprises an illuminator 7, a reference mirror 8, a beam splitter 9, and a camera 10 with associated optical imaging systems, is aligned with the placement direction 5. The measurement field 11 of the coherent-radar device 8 corresponds approximately to the area of the projection of the tooth 4 to be restored and the adjacent teeth in the Z-direction 5.

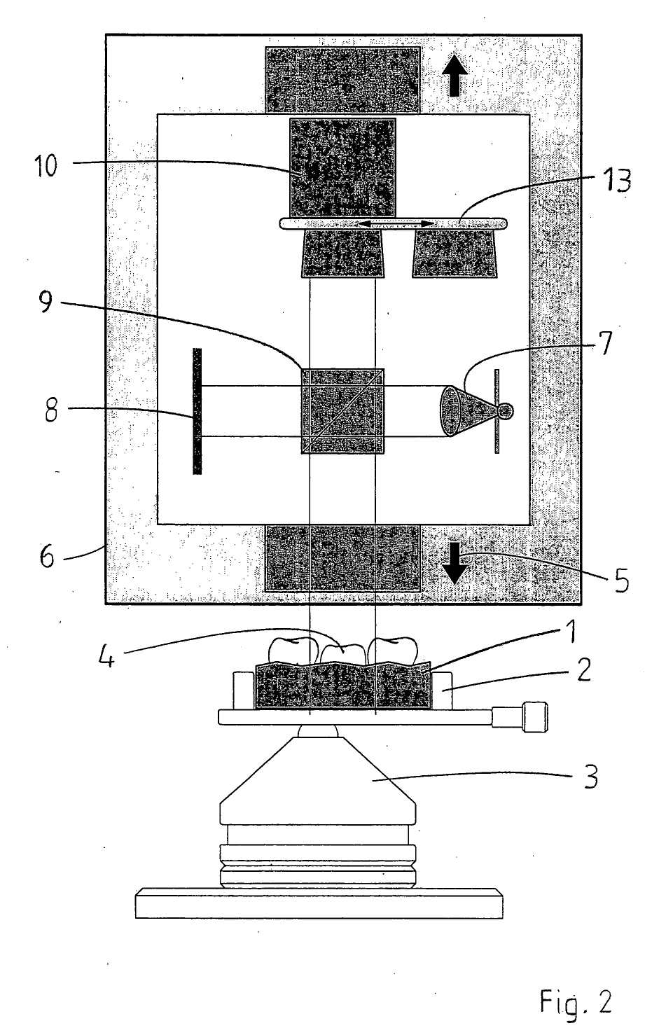

The block diagram shown in FIG. 2 essentially corresponds to the block diagram of FIG. 1, where the same elements are provided with the same reference numbers. Therefore, reference can essentially be made to the above description of FIG. 1.

The difference between FIG. 1 and FIG. 2 is in the means and method to enlarge the measurement field 11. In FIG. 1, there is a magnetic tilting table 3 that can move orthogonal to the Z-axis 5 in order to be able to record overlapping images of the cast model 1. For this purpose, the magnetic tilting table 3 is fixed on a moving sled 12. In contrast, FIG. 2 shows a coherent-radar device 6 with a camera 10, which is equipped with a changing objective 13 in order to be able to enlarge the measurement field 11 if necessary.

1. Method for optical measurement of a cast model of a dental restoration tooth in restorative dentistry, comprising:
aligning a coherent-radar device to the cast model of the tooth to be restored with dental restoration and/or vice versa, so that a direction of a measurement beam of the coherent-radar device generally coincides with an insertion or placement direction of the dental restoration tooth, defining a Z-direction,
performing the alignment with help from a real-time video image, which shows at least the tooth to be restored from the Z-direction of the coherent-radar device, and then
measuring the cast model with the coherent-radar device.

2. Method according to claim 1, further comprising aligning the cast model of the tooth to be restored on a magnetic tilting table outside of the coherent-radar device and then introducing the cast model into the coherent-radar device for measurement.

3. Method according to claim 1, wherein the measurement of the cast model is performed by the coherent-radar device with light at a bandwidth between 3-40 nanometers.

4. Method according to claim 1, further comprising performing an additional measurement sot that two measurements are performed for enlarging a measurement field of the coherent-radar device, where the cast model is shifted in a defined manner relative to the coherent-radar device and orthogonal to the Z-direction.

5. Method according to claim 1, further comprising performing a second measurement so that two partially overlapping measurements are performed for enlarging a measurement field of the coherent-radar device, where the shift of the cast model relative to the measurement field or vice versa is determined by a computer with reference to an overlapping part of measurement data.

6. Method according to claim 1, further comprising enlarging a measurement field by providing an exchangeable camera objective in the coherent-radar device.

7. Device for optical measurement of a cast model of a tooth in restorative dentistry, comprising:
a coherent-radar device (6) and a sample holder (2) for the cast model (1) of a tooth (4) to be restored with dental restoration,
the coherent-radar device (6) and/or the sample holder (2) are adjustable such that a direction of measurement beams of the coherent-radar device (6)) can be brought generally into alignment with an insertion or placement direction (5) of the dental restoration, defining a Z-direction,
a camera (10) for recording a real-time video image, which shows at least the tooth (4) to be restored from the Z-direction (5) of the coherent-radar device (6), and
a display device for showing a recorded real-time video image.

8. Device according to claim 7, wherein he sample holder (2) comprises a magnetic tilting table (3).

9. Device according to claim 7, wherein a light source (7) of the coherent-radar device (6) has a bandwidth between 3-40 nanometers.

10. Device according to claim 7, wherein the sample holder (2) can be shifted in a defined manner orthogonal to the Z-direction (5) of the coherent-radar device (6).

11. Device according to claim 7, wherein the coherent-radar device (6) is equipped with an exchangeable camera objective (13).
